(19) United States
(12) Patent Application Publication
(10) Pub. No.: US 2015/0104778 A1
(43) Pub. Date: Apr. 16, 2015

(54) SYSTEM AND METHOD FOR COMPUTER BASED MENTORSHIP

(71) Applicants: CHI-CHANG LIU, Concord, CA (US); PHILIP LIU, Concord, CA (US)

(72) Inventors: CHI-CHANG LIU, Concord, CA (US); PHILIP LIU, Concord, CA (US)

(21) Appl. No.: 14/512,333

(22) Filed: Oct. 10, 2014

Related U.S. Application Data
(60) Provisional application No. 61/890,034, filed on Oct. 11, 2013.

(51) Int. Cl. G09B 7/04; G09B 5/08; G09B 5/02

(52) U.S. Cl. CPC G09B 7/04; G09B 5/02; G09B 5/08
USPC 434/335; 434/353

(57) ABSTRACT

A computerized interactive learning system includes a display device and a compatible input device. The display device provides work items to a learner. The input device detects input activities from the learner in response to the work item. The system analyzes the input activities at two or more tiered levels of granularity. The display device provides conditional feedback to the learner based on the analysis. The input device and the display device can be incorporated into an integrated touchscreen.

### CROSS REFERENCE TO RELATED APPLICATIONS

This non-provisional and continuation-in-part application claims the benefit of provisional application No. 61/890,034, filed Oct. 11, 2013, same title, which application is incorporated herein in its entirety by this reference.

### BACKGROUND

The present invention relates to systems and methods for providing continuous monitoring and immediate personal feedback to every learner in a group in the fashion similar to a personal tutor or a human mentor

Traditional personal tutor and education mentor watch over a student continuously to identify his learning strength and weakness and provide various types of timely feedback, such as praise and warning, to improve his learning efficiency and reduce frustration. This personalized learning style has been shown to be much more effective than the group-based learning style commonly practiced in the public schools today. However, human tutors and education mentors can't perform in a consistent fashion due to physical and mental limitations. Additionally, a trusting human relationship is almost always required for a successful mentorship. That relationship often requires time to build up. Other practical considerations such as the cost factor and the limited supply of qualified human tutors and education mentors make this desirable practice impractical for a great percentage of the student population. As a result, the group-based public school education systems and their education performance in many communities are not improved despite of the best intent of the administration.

Modern computing and advanced artificial intelligence technologies allow machines to analyze the correctness of a student's answer to a test question and then generate personalized study content accordingly to help improve that student's learning. Prior art in the computerized personalized learning field also includes a system that analyzes a student's response to a math problem at pre-determined process points so as to identify his weak problem-solving process steps. These systems operating based on snapshots of the student's work at pre-determined process points not only miss the fine thinking-process information that are lost between snapshots but also unable to offer adequate timely feedback, like a human tutor or education mentor does, that significantly enhances the student's learning experience altogether.

For example, a system based on the snapshot analysis is often blind to any student's work process that was produced and then erased between adjacent snapshots. Consequently, the information about the student's struggle in the knowledge area or problem solving skills related to the erasure is lost forever. Further, computer based learning systems that focus solely on detecting and addressing student's mistakes and weakness may discourage the student from further study and even cause damage to his self-esteem.

It is therefore apparent that an urgent need exists for a more human tutor-like computerized learning system that provides continuous monitoring and immediate feedback to a learner for encouragement, warning and event hints, for example. This improved personalized learning assistive system can be integrated at various levels into almost any existing education system to enable a large number of students to enjoy a personalized education experience with great learning efficiency potential.

### SUMMARY

To achieve the foregoing and in accordance with the present invention, systems and methods for interactive learning with conditional feedback is provided.

In one embodiment, a computerized interactive learning system includes a display device, a compatible input device and a processor. The display device is configured to provide a work item to a learner, while the input device is configured to detect input activities from the learner in response to the work item. The processor is configured to analyze the input activities at two or more tiered levels of granularity.

In this embodiment, the display device is further configured to provide feedback to the learner, wherein the feedback includes at least one of praise, warning, hint, progress evaluation and performance evaluation. The feedback can be provided whenever a pre-defined condition is met based on the analysis of input activities.

In some embodiments, the input device and the display device are incorporated into an integrated touchscreen. It is also possible for the input device and the display device to be separate devices, for example, an X-Y input tablet operatively coupled to a separate display screen that has no user input capability.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an exemplary embodiment of the present invention for a single-learner application;

FIG. 2 is an exemplary embodiment of the present invention for a multi-learner application;

FIG. 3 describes some operation details of FIG. 2;

FIG. 4 describes more operation details of FIG. 2;

FIG. 5 is an exemplary embodiment of an analysis output of the system in FIG. 2;

FIG. 6 is another exemplary embodiment of the present invention for a multi-learner application;

FIG. 7 is an exemplary embodiment of the process flow of a system illustrated in FIG. 1;

FIG. 8 describes more details of FIG. 7;

FIG. 9 is an exemplary embodiment of the information storage mechanism used in one of the preferred embodiment of the present invention;

FIG. 10 is an exemplary embodiment of one of the user interface implementation;

FIG. 11 and FIG. 11A describe an exemplary embodiment of the present invention for a tablet based single-learner application; and

FIG. 12 and FIG. 12A describe another exemplary embodiment of the present invention for a tablet based single-learner application.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to systems and methods for providing continuous monitoring and immediate personal feedback to every learner in a group in the fashion similar to a personal tutor or a human mentor.

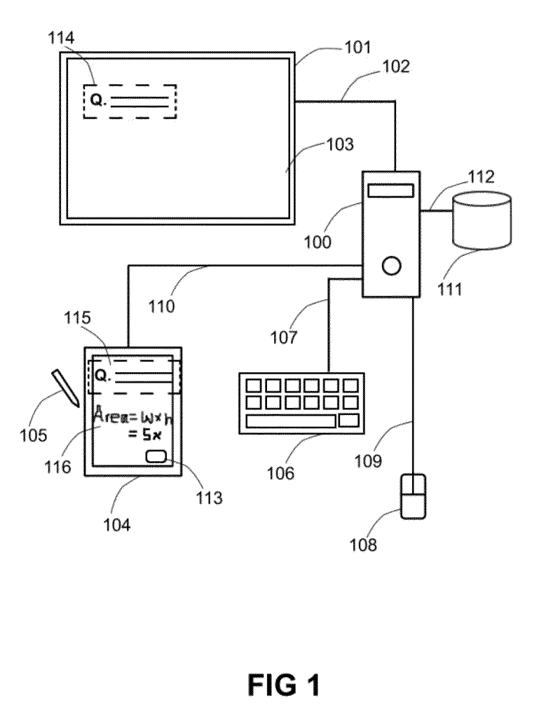

To facilitate discussion, FIG. 1 shows an exemplary embodiment of the present invention. A display unit 101 is operationally connected to CPU 100 by link 102, which may be a wired or wireless link. A touchscreen tablet 104 is functionally connected to the CPU 100 by link 110, which may be a direct link or a network link. CPU 100 is also connected to keyboard 106 by link 107, which may be wired or wireless, and to mouse 108 by link 109, which may be wired or wireless. In FIG. 1 a dedicated stylus pen 105 is used for precision hand-drawing input. In one preferred embodiment of the present invention where a capacitive touch screen 10 is used in 101, device 105 may be a simple static-conducting stylus that works on 103 like a human finger with a smaller tip. In another preferred embodiment of the present invention, device 101 may work like the Samsung Galaxy Note 2 smart phone, where the Wacom digitizer technology is also built in to allow for both finger input and a precision digitizer pen 105 input on 103. FIG. 1 shows an application of the present invention where a test is administered by a teacher, not shown in the drawing, using mouse 108 and keyboard 106. A short-answer math test item 114 displayed on screen 103 is also displayed on device 104 as 115. A student, not shown in the drawing, may use stylus 105 on the screen of 104 to work out the solution. As the student, who is not shown in FIG. 1, goes through the problem solving process, the work 116 that he produced on the screen of device 104 is captured as a sequence of commands, events and data created on device 104 along with the associated time stamps. In one embodiment of the present invention a graphical button 113 on the screen of device 104 lets the student, not shown in the drawing, submit his work with the final answer to CPU 100 in an electronic form, which may be multi-media in nature, for example, when clicked. Although not shown in FIG. 1, CPU may automatically grade the student's submission based on pre-defined rules and artificial intelligence algorithms, for example. Depending on the application and the corresponding configurations, storage device 111 that's functionally connected to CPU 100 by link 112 stores both the submitted answer file and the student's process information data at a specific resolution and granularity level so that the student's entire problem solving work process can be reconstructed at that level later on. Depending on the application and the configuration of the system, the system may analyze the student's on-going work during problem solving process at different contextual levels and modify the display content 115 accordingly. For example, the system may automatically detect and translate the appropriate portions of his handwriting into mathematic equations and then to determine and warn him if there is a calculation error by displaying a warning message, not shown in the drawing, on the screen of 104. Another example would be that, if the system detects that several minutes have passed and the student, not shown in the drawing, is still struggling with formulating the problem, the system may display hints, not shown in the drawing, on the screen of 104 as how the problem may be formulated. Another example would be that, based on the past performance, the system may display, not shown in the drawing, an estimated time remaining for the student to complete test item 115. For security reasons, data transmitted over link 110 and link 112 may be encrypted and that access to the data stored on 111 is protected. Additionally, depending on the application, accessing certain data may require special permission. Especially when data stored on 111 covers more than one student and over a long period of time, the data may be compressed and organized in a specific database format for efficiency considerations. As some of the collected raw user activity information may not be useful for a particular application, CPU 100 may screen out redundant and irrelevant user activity information before further processing. In another exemplary application of the present invention item 114 and item 115 are a homework assignment item. A tutor, who is not shown in the drawing, uses devices 106 and 108 to interact with the student, who is not shown in the drawing, and monitors the student's work progress on 101 remotely. As the student's work progress is collected and analyzed at multiple contextual levels on CPU 100 in real-time, the analysis result may alert the student and the tutor, both not shown in the drawing, of issues that he may have been unaware of, for example. Further, based on the data stored on 111, when the student, not shown in the drawing, completed a homework item, CPU 100 may analyze his present performance against past history for homework performance progress tracking And, when the student comes across an assignment that he has had problem with in a previous test, CPU 100 may remind the student about that test item and give him an opportunity to review that test item or related cross-subject knowledge to enhance knowledge retention, for example.

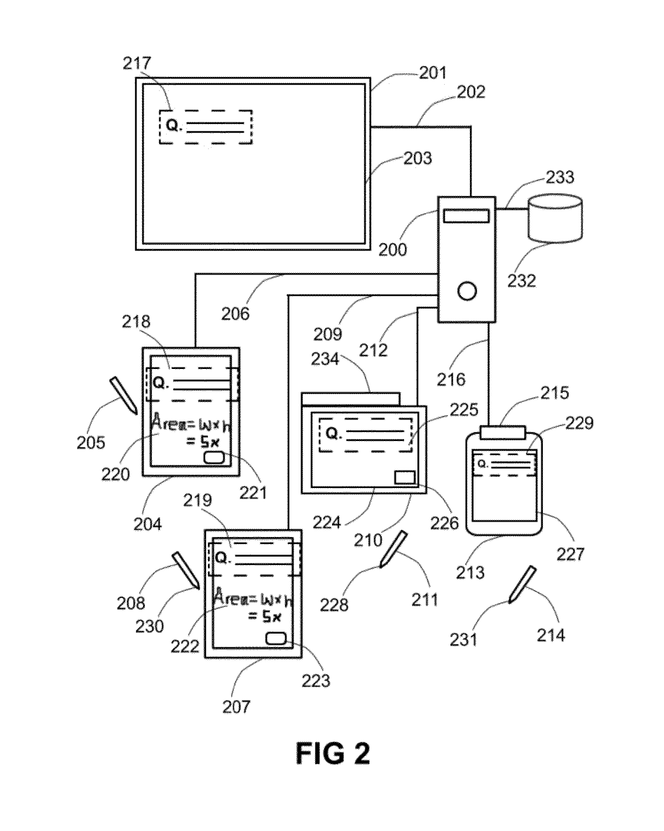

FIG. 2 shows an exemplary embodiment of the present invention where multiple students may take a short-answer math assessment test at the same time. A display unit 201 is operationally connected to CPU 200, which manages the entire assessment application, by link 202, which may be a direct link or a network link. A touchscreen tablet 204 used by student #1, who is not shown in FIG. 2, is connected to the CPU 200 by link 206, which may be a direct link or a network link. Another touchscreen tablet 207 used by student #2, who is not shown in the drawing, is connected to the CPU 200 by link 209, which may be a direct link or a network link. A specialized wireless digitizer tablet 210 coupled to digitizer pen 211 is connected to CPU 200 by wireless link 212 is used by student #3, who is not shown in the drawing. Unlike the common digitizer tablet, device 210 also has a display unit 234, which may be integrated into 210 or attached to 210 as an accessory, for example. With a pressure sensitive tip 228 that is also filled with ink, student #3, not shown in the drawing, uses digital pen 211 like a pen to write on the sheet paper 224 that's placed over the work surface of tablet 210. While writing on sheet paper 224, the position of tip 228 over tablet 210 is transmitted to CPU 200 with time information so that an electronic record of student #3's work process on tablet 210 is saved on CPU 200. Also connected wirelessly by link 216 to CPU 200 is an ultrasound sensor-transceiver device 215 coupled to an ink-filled digital pen 214, which writes like a regular writing pen on sheet paper 227 that's properly clipped to notepad 213. When sensor 215 detects that the tip 231 of digital pen 214 is pressed down by student #4, who is not shown in FIG. 2, sensor 215 starts tracking the position of tip 231, recording the position of tip 231 over the sheet paper 227 and transmitting the position information with time stamps to CPU 200 continuously until tip 231 is released. Thus, an electronic record of the student's work process on notepad 213 is created and kept on CPU 200. Alternatively, a digital paper using printed navigation landmarks invented by Anoto may be used in conjunction with a Livescibe-like digital camera pen, with the ability to store the time stamp information for each event, to accomplish the same effect. In FIG. 2, student #1 may use stylus 205 on device 204 to solve test item 218, whose content are sent from CPU 200 to all connected display-enabled student devices: 204 and 207. In contrast, students #3 and #4 using devices 210 and 213, respectively, write on sheet paper with the question item printed and prepared specifically for their devices. During the test, each student may have questions or difficulties in different areas and attack the problem in different ways. For example, student #2, not shown in the drawing, on touchscreen device 207 may have difficulties formulating the problem. In this embodiment of the present invention CPU 200 may display a message 223 on 207 exclusively to ask student #2 if help is needed, if there is no activities on device 207 detected for 2 minutes after the test item was first displayed. Depending on student #2's response to the message, hints to help student #2 solve present test item 219 may be displayed on device 207 or that the message box 223 may disappear and let student #2 continue to work on his own. Depending on the type and the demand frequency of hints, for example, CPU 200 may even update the display content on 203 to make the commonly requested hints available to everyone in the room. As student #2, not shown in the drawing, progresses further, different messages may show up in message box 223 to initiate different customized content display on device 207. Eventually when the student has completed the test item, he may tap on message box 223 or another dedicated box, not shown in FIG. 2, which is marked for answer submission, to submit his final answer along with the present work kept on device 207. Unlike all prior art systems, CPU 200 may record the entire problem solving process of student #2, not shown in the drawing, with and without integration to test item 219 displayed on device 207. That is, for example, CPU 200 may save all the events and touch input information that device 207 detected throughout the test session. With the time stamp associated to each detected activity saved, the entire work process can be easily reconstructed at any desired space resolution or speed and that specific types of events or activities may even be removed in the reconstruction, for example. Although not shown in the drawing, CPU 200 may execute an analysis function to trace through the saved students' work process data and identify and interpret characteristics and patterns in the problem solving process so that student's weaknesses in subject area and test taking may be identified. Although not shown in FIG. 2, CPU 200 may also allow the teacher to monitor the individual student's progress on-site or remotely using devices that are not shown in the drawing. Additionally, teacher may also activate real-time or off-line analysis of data available to CPU 200 on an individual student, a selected sub-group or the entire group for different purposes and at different levels of time scale and data or context granularity. The work process data collected on CPU 200 and saved in 232 may also be used for cheating prevention. That is, if the work process data is inconsistent with the submitted final answer or if the work process between two students is extremely similar including errors, then there is a high probability of cheating involved, for example.

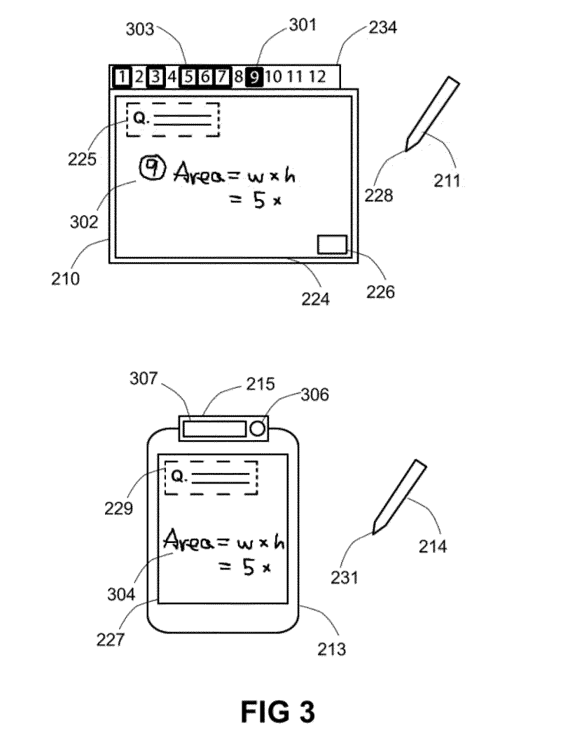

FIG. 3 shows more operation details of device 210 and device 213 of FIG. 2. In FIG. 3 student #3, who is not shown in the drawing, uses digital pen 211 that also works like a regular ball point pen and has a pressure sensitive tip 228 to write on a test sheet 224, which is placed securely at a fixed location over the surface of digitizer tablet 210, to solve test item 225 that is printed on sheet 224. In one embodiment of the present invention, student #3, who is not shown in the drawing, first clicks on the “start/submit” button 226 to register the test sheet and start work process recording. That is, when 228 is pressed down on button 226 on device 210 the first time, device 210 sends a signal to CPU 200, which is not shown in the drawing, to register the present active answer sheet 224 for device 210 and start recording all user activities take place on device 210. Upon receiving that register information, CPU 200 updates the device 210 status information in the application memory and sends back a response message to mark the corresponding test item label 301 in display unit 234. Although not shown in the drawing, when multiple test items are printed on the same test sheet, labels of all the corresponding test items may be marked by the response message. As student #3, who is not shown in the drawing, works through the problem solving process, all of his activities with device 210 and pen 211 are captured with time stamps and sent to CPU 200, which is not shown in FIG. 3. When student #3, not shown in the drawing, is done with test item 225, he uses pen 211 to click on the printed “start/submit” button 226 to submit his answer along with a snapshot of the work produced on 224. In one embodiment of the present invention, the location of the “start/submit” button 226 identifies test item 225 uniquely. In another embodiment, a printed circuit, not shown in the drawing, may be embedded in or attached to test sheet 224 at a specific location so as to be detected by device 210 automatically for identification of test sheet 224. Alternatively, multiple embedded printed circuits, not shown in the drawing, may be used together to identify the corresponding test sheet and test items. Upon receiving the answer submission, CPU 200, not shown in FIG. 3, sends a reply message, not shown in the drawing, to update the corresponding test item marking as completed on device 210. Student #3, not shown in the drawing, may then repeat the same process for a different test item printed on a different sheet until the entire test set is done. Although not shown in FIG. 3, additional software buttons may be used on sheet 224 for other specific purposes. For example, check boxes for identifying the present test sheet, check boxes for identifying the present test item, or a button for clearing all past work done on the present test sheet, when student #3, not shown in the drawing, decides to erase all previous work and start over with a clean sheet. Device 213 and the coupled digital pen 214 work in a similar fashion to device 210 and digital pen 211. That is, in one embodiment, after test sheet 227 is placed on notepad 213 at a fixed location, student #4, who is not shown in FIG. 3, may tap pen tip 231 of device 214 at a specific marked location, not shown in FIG. 3, on sheet 227 to register the present test sheet and corresponding test items on CPU 200, not shown in the drawing. Alternatively, one or more rotary buttons like 306 may be used in conjunction with display 307 to perform the register task. Although not shown in FIG. 3, in one embodiment of the present invention, unit 215 has a built-in memory that stores the present status of the test. Upon receiving the test sheet information from device 213, CPU 200, not sown in FIG. 3, then update that information in the application memory and sends back a reply message to update unit 215's internal memory, not shown in the drawing, and change the corresponding test item label in display unit 307 correspondingly. As student #4, who is not shown in the drawing, works through the problem, all of his activities with unit 215 and pen 214 are captured and save in unit 215 with time stamps and sent to CPU 200, which is not shown in FIG. 3. When student #4, not shown in the drawing, is done with the present test item, he may use pen 214 to tap on a printed “submit” box, not shown in FIG. 3, on sheet 227 to submit his answer along with a snapshot of his work process data, as saved in 215, for the present test item. Alternatively, he may button 306 on unit 215 to execute the submission. Upon receiving the submission, CPU 200, not shown in FIG. 3, sends an acknowledge message to update the information stored in unit 215 memory, which is not shown in FIG. 3, and change the corresponding test item marking in display 234 to the complete status. Student #4, not shown in the drawing, may then repeat the same process for a different test item printed on a different sheet until the entire test set is done.

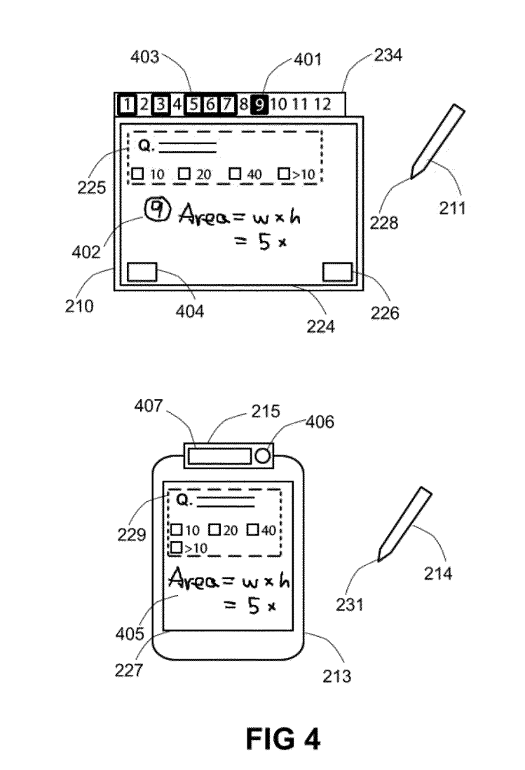

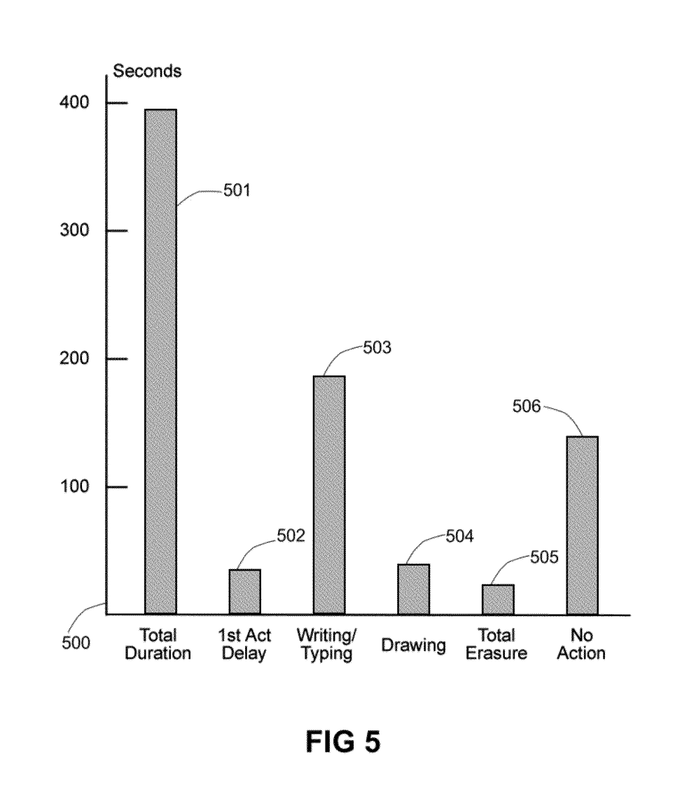

FIG. 4 shows more operation details of device 210 and device 213 of FIG. 2 for a multi-choice math test item application. In FIG. 4 student #3, who is not shown in the drawing, uses digital pen 211, which also works like a regular ball point pen and has a pressure sensitive tip 228, to write on the test sheet 224, which is placed securely at a fixed location over the surface of digitizer tablet 210, to solve test item 225. In one embodiment of the present invention, student #3, who is not shown in the drawing, first taps on the “start/submit” button 226 to register test sheet 224 on CPU 200, not shown in the drawing. That is, when button 226 is tapped the first time on device 210, device 210 sends a signal to CPU 200, which is not shown in the drawing, to register present answer sheet 224 for device 210. Upon receiving that information, CPU 200 updates the status information for device 210 and device 211 in the application memory and sends back a response message to update the corresponding test item label 401 in display unit 234 accordingly. Although not shown in FIG. 4, unit 234 has a built-in memory where the present status of all test items is stored. Although not shown in the drawing, when multiple test items are printed on the same test sheet, labels of all the corresponding test items will be handled by the process. As student #3, who is not shown in the drawing, works through the problem solving process for test item 225, all of his activities with pen 211 is captured with time stamps and sent to CPU 200, which is not shown in FIG. 4. When student #3 has completed the problem solving and marked the answer boxes of his choice, he uses pen 211 to click on the printed “start/submit” box 226 on sheet 224 to submit his final answer along with a snapshot of worksheet 224 to CPU 200, which is not shown in FIG. In one embodiment of the present invention, the location of the “start/submit” button identifies the test item. In another embodiment, a printed circuit may be embedded in or attached to test sheet 224 at a specific location so as to identify test sheet 224 uniquely and automatically. Alternatively, multiple printed circuits or a different type of ID tag, such as RFID, may be used to carry an identification code representing the corresponding test sheet and test items. Depending on the application and the system configuration, upon receiving the answer submission, CPU 200, not shown in FIG. 4, may perform a check on the submitted answer and warn the student if there is inconsistency with the answer just submitted. For example, the set of answer boxes that he had selected in his answer submission is inconsistent. Alternatively, CPU 200, not shown in the drawing, just sends a reply message to device 210 so that the corresponding test item marking in display 234 is changed to completion like item 403. Student #3, not shown in the drawing, may then repeat the same process for a different test sheet, not shown in the drawing, with a different test item printed, until the entire test set is done. Although not shown in FIG. 4, additional buttons like 226 may be available on sheet 224 for other purposes. For example, a location specific button for calling for help, a location specific button for identifying the present test item, a location specific button for clearing the past work done on the present test sheet, when student #3 decides to scratch the past work and start over with a clean sheet, or a button for replacing previously submitted work and answer with the present submission. For student #4, who is not shown in the drawing, device 213 and its coupled digital pen 214 work in a similar fashion. That is, in one embodiment, after test sheet 227 is placed on notepad 213 at a fixed location, student #4, who is not shown in FIG. 4, taps the tip 231 of device 214 at a specific marked location, not shown in FIG. 4, on sheet 227 to register test sheet 227 with devices 214 and 215 on CPU 200 for present application. Alternatively, rotary button 406 may be used in conjunction with display 407 to perform that task. Although not shown in FIG. 4, unit 215 has a built-in memory where the present status of all test items is stored. Upon receiving the test sheet information from device 215, CPU 200, not sown in FIG. 4, then updates the information in the application memory and sends a reply message to update unit 215's internal memory, not shown in the drawing, and update the corresponding test item label in display unit 407 correspondingly. Although not shown in the drawing, when multiple test items are printed on the same test sheet, labels of all the corresponding test items will all be marked correspondingly. As student #4, who is not shown in the drawing, works through the problem solving process, all of his activities with pen 214 and device 215 are captured by unit 215 with time stamps and sent to CPU 200, which is not shown in FIG. 4. When student #4 has completed the problem solving and marked the answer boxes of his choice, he uses pen 214 to click on the printed “submit” box, not shown in FIG. 4, on sheet 227 to submit his final answer along with a snapshot of his work on sheet 227. Alternatively, button 406 on unit 215 may be used for answer the submission. Upon receiving the submission, CPU 200, not shown in FIG. 4, sends a reply message to unit 215 to update the information stored in unit 215's memory, which is not shown in FIG. 4 and subsequently changes the corresponding test item marking in display 234 to the completion status. The same process is repeated for all test sheets until the entire test set is done.

FIG. 5 shows an example of a student work process data analysis output of CPU 200 in FIG. 2. In FIG. 5, the time-expenditure profile of a student's activity for taking a specific test item is constructed in bar chart 500 consisting of 6 items: bar 501 for the time duration for the test item, bar 502 for the time elapsed before the first recorded problem solving activity is detected, bar 503 for the total writing and tying time, bar 504 for the total time spent on making drawings, bar 505 for the total time spent on erasing or deleting previous work, drawing or typing and bar 506 for the total time when no meaningful activities were detected.

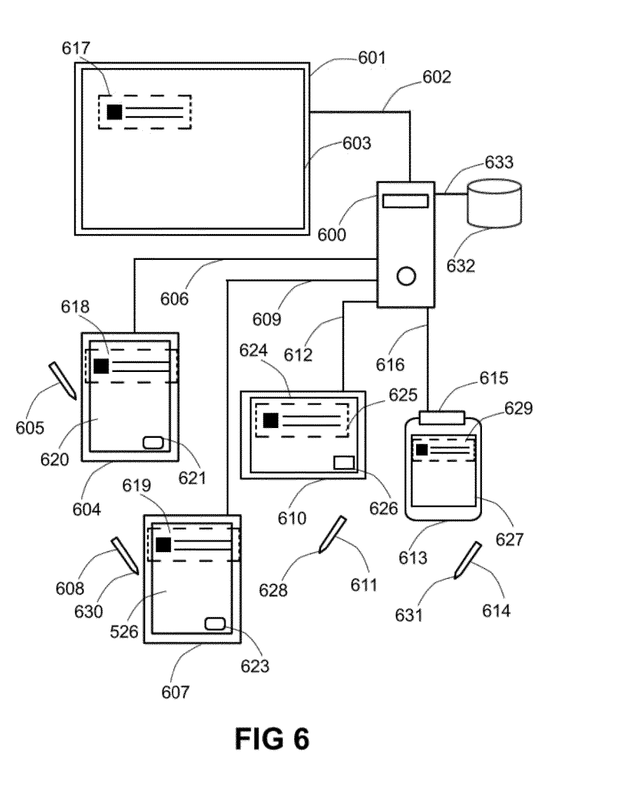

FIG. 6 shows an exemplary embodiment of the present invention where multiple students participate in a collaborative learning session. A display device 601 is operationally connected to CPU 600, which manages the entire group learning application, by link 602. A touchscreen tablet 604 used by student #5, who is not shown in the drawing, is functionally connected to CPU 600 by link 606, which may be wired or wireless. Another touchscreen tablet 607 used by student #6, who is not show in the drawing, is functionally connected to CPU 600 by link 609, which may be wired or wireless. A wireless digitizer tablet 610 coupled to digitizer pen 611 is connected to CPU 600 by wireless link 612 and used by student #7, who is not shown in the drawing. With a pressure sensitive tip 628 that is also filled with ink, student #7, not shown in the drawing, uses digital pen 611 to write like a pen on the sheet paper 624 that's placed over the work surface of tablet 610. While writing on sheet paper 624, the position of tip 628 over tablet 610 is transmitted to CPU 600 with time information so that an electronic record of student #7's work process on tablet 610 is saved on CPU 600. When the system is under a specific condition, another copy of the student activity record is also saved on storage device 632, which is functionally connected to CPU 600 by link 633. Also connected wirelessly by link 616 to CPU 600 is an ultrasound sensor-transceiver device 615 coupled to an ink-filled digital pen 614, which writes like a regular writing pen on sheet paper 627 that's properly clipped to notepad 613. When sensor 615 detects that the tip 631 of digital pen 614 is pressed down by student #8, who is not shown in FIG. 6, sensor 615 starts tracking the position of tip 631, recording the position of tip 631 over the sheet paper 627 and transmitting the position information with time stamps to CPU 600 continuously until tip 631 is released. Thus, an electronic record of the student's work process on notepad 613 is created and kept on CPU 600. Alternatively, a digital paper using printed optical navigation landmarks, such as the one invented by Anoto, may be used in conjunction with a digital camera pen, which is capable of tracking and storing all movements of the pen with time stamp information for each event, to accomplish the same effect. One of the advantages of using a digital camera pen is the ability to recognize a specific test sheet 627 and, possibly, even the individual test items, simply because that the navigation landmarks on each paper is locally and globally unique to a great degree. In FIG. 6, learning material 617 is distributed to all 4 student devices, either electronically or in a properly paper form, to allow students to add notes conveniently and save the notes into electronic files. Because the digital notes are saved as separate entities from the original learning material, they can be easily extracted and manipulated for sharing and other purposes. For example, while a student is taking hand-written notes on his device, the system may translate his handwriting into text in real-time and detects and highlights keywords that deserve more attention or further research. In one embodiment, the highlighted keywords are embedded with hotlinks so that relevant information or resources can be displayed on his device with a tap on the keyword. Other examples include: the teacher may review the notes taken by individual students and help them to improve their notes-taking skill, the notes from entire class may be merged automatically into one superset for sharing, discrepancies between the notes taken by different students can be quickly identified and brought to teacher's attention, and etc. Although not shown in FIG. 6, a teacher, not shown in the drawing, may use one of the input devices or, an additional input means, not shown in the drawing, to manage the system for switching between different applications and managing the student devices on the fly. For example, after the lecture presentation, the teacher, not shown in the drawing, may post a quiz on 603 and collect answers from the students' devices. After the students' answers are automatically graded by CPU 200, which is not shown in the drawing, the teacher, who is not shown in the drawing, may switch the system to the discussion mode and allow student to post questions and hold discussions. For example, in FIG. 6, student #5, not shown in the drawing, may tap on “request” button 621 on device 604 to request permission to post a question or comment that he has already written on 620 onto 603 to initiate a discussion or solicit an answer. And, with permissions granted by the teacher, not shown in FIG. 6, more than one student, not shown in FIG. 6, may use devices 604, 607 and 610, for example, as input devices to write to a shared whiteboard window, not shown in the drawing, on 603, simultaneously or in an orderly fashion, for example. Depending on the configuration, CPU 600 may record the screen activity of 603; including all the participation activities of all students, so that the information can be analyzed later on to help improve the lecture content and delivery as well as track student's participation and understand the individual student's learning needs, for example.

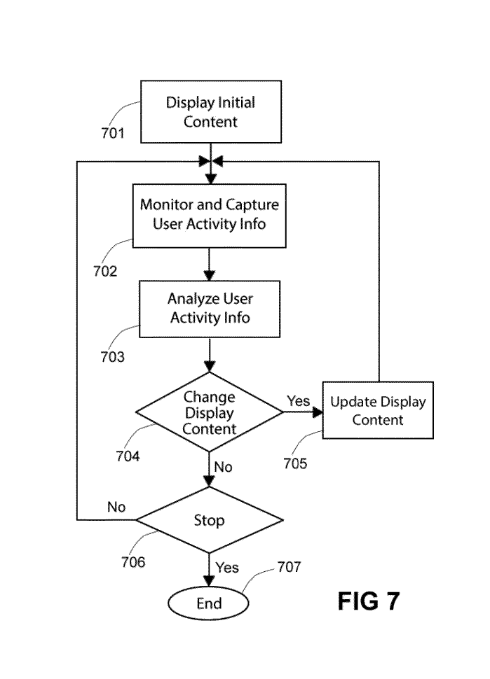

FIG. 7 shows the process flow of one embodiment of the present invention illustrated in FIG. 1. In Block 701 the content for the initial display is distributed to the student device from CPU 100. In Block 702, the system monitors and captures student's activities performed on device 104 in response to the current display content. In Block 703 the collected activity information, including user data, is analyzed. Based on the analysis result from Block 703 and other related configurations, the system determines if the present content displayed on the student's device should be changed. In block 705, new content is created and displayed on the student's device. The above sequence of steps from block 702 to block 702 continues until a specific condition is detected. The application is then terminated.

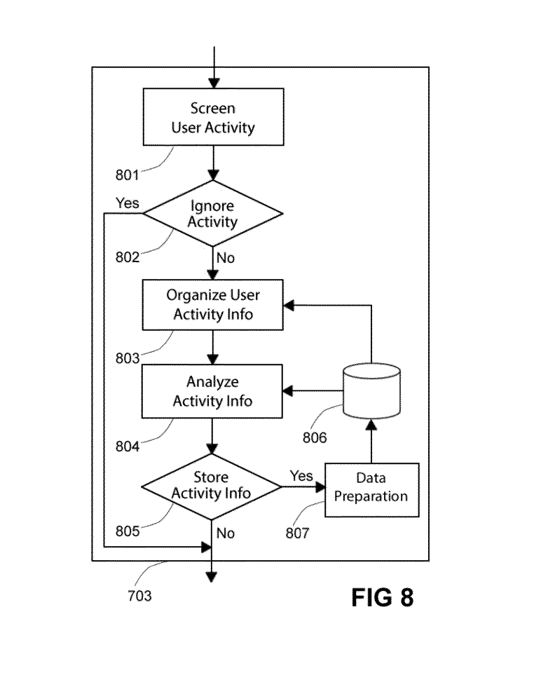

FIG. 8 describes more details of Block 703 in FIG. 7. In Block 801 CPU 100 determines if the collected user activity information is relevant to the present application. For example, if a student taps on another application that is purposely disabled by the present application, that event information will be screened out without further processing or recording. Conversely, if the teacher is interested in collecting the internet activity information of a particular student, he may screen out all other activities and only process the internet activity related events, commands and data detected on that student's device, for example. In Block 803, the received student activity information is organized into meaningful form. For example, when the system detects that the student is making a gesture or a hand-writing input on a touchscreen, the system may start organizing the present information with future information into a gesture unit or an alpha-numeric unit before moving to Block 804 to analyze the information. The translation of hand-writing input into texts and symbols may require models that are saved in storage device 806. In Block 804, both the present information collected from the student device and the past information relating to the same student may be used to analyze his performance or special needs, for example. Depending on the analysis result and other related configurations, the collected information as well as the analysis results may be processed in Block 807 and then saved into storage device 806.

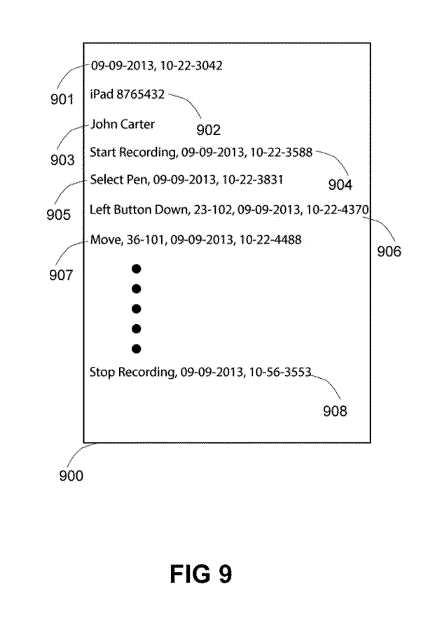

FIG. 9 shows an exemplary embodiment of information stored in an activity record file 900. Item 901 shows the date and time when the activity recording command was initiated. Item 902 shows the device that the activities were recorded from. Item 903 shows the registered name of the user for the recorded device. Item 904 shows that the first recorded event is a “start recording” command, occurred at 22 minutes 35.88 seconds past 10 AM, Sep. 9, 2013. Item 905 shows the second recorded activity is a “select pen” command, occurred at 22 minutes 38.31 seconds past 10 AM. Item 906 shows that the third recorded event is a Left Mouse Button Down event at screen location x=23, y=102 and occurred at 22 minutes 43.70 seconds past 10 AM. Item 907 shows that the fourth recorded event is a pointer position change event at screen location x=36, y=101 and occurred at 22 minutes 44.88 seconds past 10 AM. Item 908 shows that the last recorded command is the “stop recording” command, occurred at 56 minutes 35.53 seconds past 10 AM.

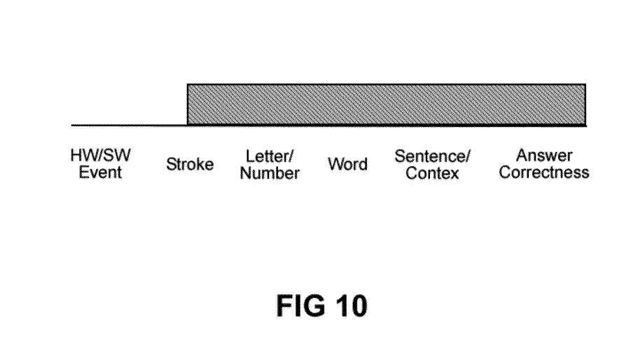

FIG. 10 shows an embodiment of the present invention of a graphical slide bar that allows the teacher to set the information and data granularity level used in Block 804 of FIG. 8. In FIG. 10, the coarsest level available is Answer Correctness. That is, depending on the correctness of the answer submitted by the student, the system decides what to display to the student device next. When the level Word is selected, the system decides what to display to the student device after each work is entered by the student. And, at the finest level Hardware/Software Event, the system analyzes the information collected after each hardware and software event to determine if the student's device display content needs to be updated. Alternatively, depending on the past performance of the student and the objective set by the teacher, the system may automatically select the most proper setting for each student.

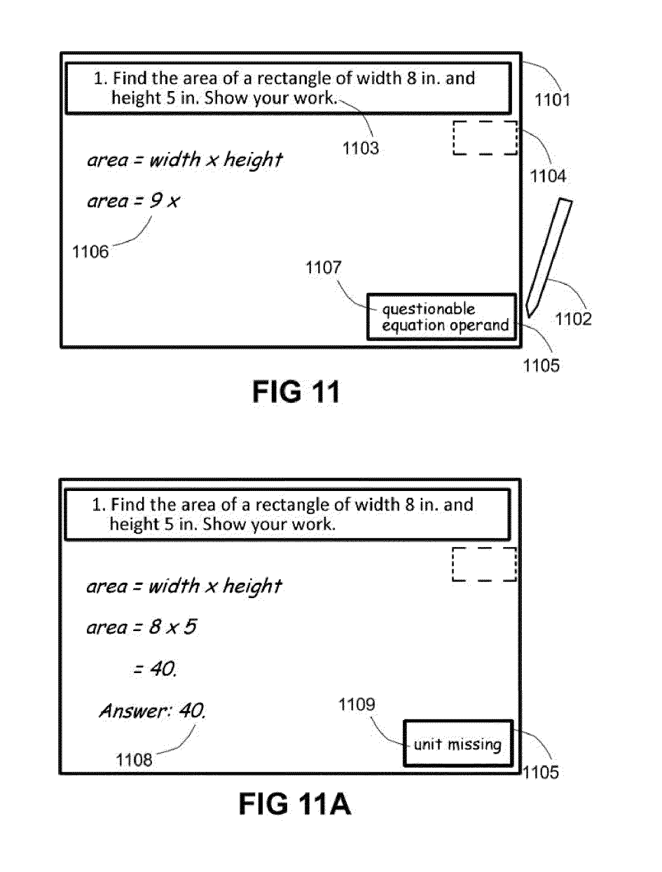

FIG. 11 shows another preferred embodiment of the present invention where a student, not shown in the drawing, is using touchscreen tablet computer 1101 with a stylus 1102 to work on a homework assignment item 1103 that asks the student to find the area of a rectangle of dimension 5-inch by 8-inch. As the student, not shown in the drawing, starts writing on tablet 1101 to formulate the problem into a mathematic equation, the internal CPU 1104 of tablet 1101 analyses the input. For example, when the student is writing out the formula for rectangle area calculation: Area=Width×Height, CPU 1104 can detect if the key words are present in the formula and then checks if one side of the formula contains the multiplication symbol “x”. If CPU 1104 detects any other arithmetic operation symbol is being written out in that formula, which is identified by the equal sign “=” and the presence of the word “area”, it may immediately display a feedback message “questionable formula”, which is not shown in the drawing, in corner 1105 of tablet 1101 to warn the student, who is not shown in the drawing, that the formula that is currently being developed may be inappropriate for the given work item. This type of feedback message helps reduce the frustration due to unintended carelessness error and ensures that the student work is focused on the subject of interest. After the student has corrected the formula and continues on to calculate the area of the rectangle, CPU 1104 checks if the correct value of the width and the height of the rectangle are used in the calculation. For example, in FIG. 11 if the number “9” is detected in what appears to be a multiplication step along with the presence of the equal sign following the keyword “area”, CPU 1104 may immediately display a feedback message 1107 “questionable equation operand” in corner 1105. And, in FIG. 11A when the student has completed the calculation of 5×8=40 and entered 40 as the answer to the homework item without specifying the unit in the answer, CPU 1104 may immediately display a feedback message 1109 “unit missing’ in corner 1105. Although not shown in FIG. 11, in one of the preferred embodiment all activities, including erasures and corrections, that the student performed on tablet 1101 in response to homework item 1103 and its related feedback messages are stored using cloud storage 1106 so that they can be retrieved later on for review and future work analysis and feedback message creation. For example, if the student, not shown in the drawing, has shown consistent problem with carrying out the division operation on his own, CPU 1104 may display a feedback message suggest to the student to use the multiplication to check his answer right after a division is carried out. In another preferred embodiment, a dedicated storage server may be used to ensure that the location of all copies of the information in storage are known and managed at all times. Although not shown in FIG. 11, CPU 1104 may use the analysis information of the work progress that the student has presented in response to work item 1103 and to its related feedback messages to determine what the next homework item should be so that greater learning efficiency can be achieved. Although not shown in the drawing, different types of feedback messages may be delivered in different styles or formats under different conditions. For example: a warning message may be delivered in a graphical format, a hint may be delivered using text, a praise may be delivered in an animated graphical format and when the student, not shown in the drawing, is working by himself, certain feedback messages may be delivered with the use of voice or sound. In general, it is preferred that the feedback messages content and delivery methods are configured to best fit the user's current needs. For example, for an early stage language learner, voice feedback with a lot of encouragement phrases should work better than just text based warning and error corrections.

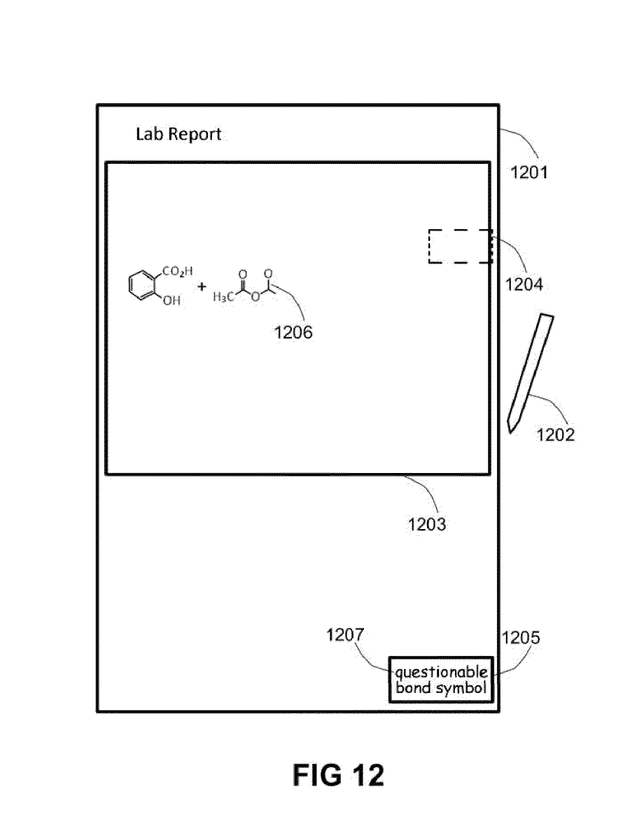

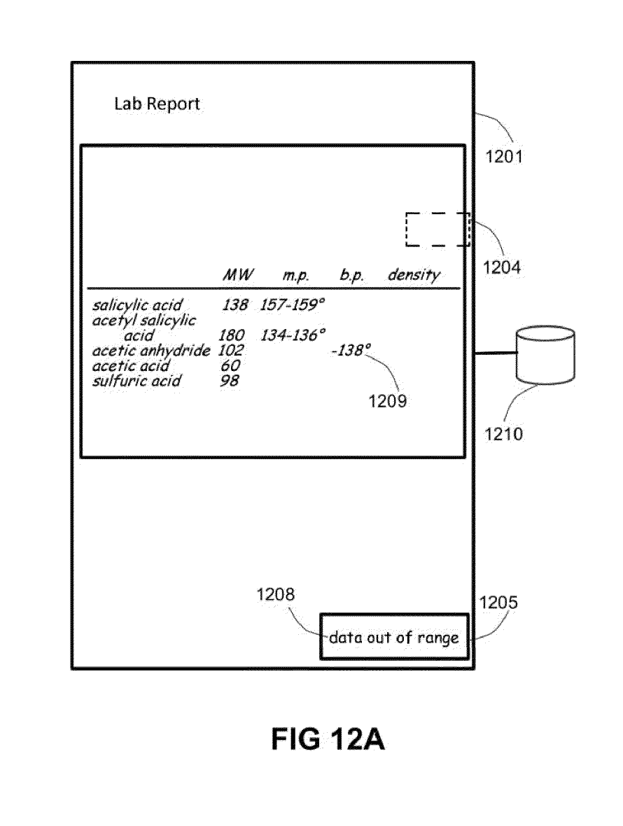

FIG. 12 shows another preferred embodiment of the present invention where a student, not shown in the drawing, is using touchscreen tablet 1201 with a stylus 1202 to work on a Chemistry Lab report. As the student, not shown in the drawing, is working on a specific section 1203 of the report, internal CPU 1204 checks the writing at different contextual levels. That is, for example, when the student is writing down the reaction formula 1205 in FIG. 12, internal CPU 1204 checks the spelling of the chemical names, the correctness of their corresponding 2D symbols, the formula structures and etc. against the pre-selected databases and sends out feedback when a misspelling, a wrong symbol or an incorrect formula is detected. For example, if the student mistakenly used a single bond symbol 1206 in FIG. 12 for the Oxygen atom instead of a double-bond, internal CPU 1204 may display a warning message “questionable bond symbol” in box 1205, or, alternatively, in a pop-up window, which is not shown in the drawing. Alternatively, CPU 1204 may flash at that single bond for a few second as a feedback warning. Additionally, CPU 1204 may also activate a warning chime. In FIG. 12A, as the student moves on to the data table section, CPU 1204 may check the value of the data entry along with their units as they are entered into the table against a set of pre-defined ranges defined in a database stored in a functionally connected storage device 1210. The database may be pre-loaded to CPU 1204 or accessed remotely by CPU as needed. By applying a set of pre-defined related rules, CPU 1024 may create and activate feedback when a particular entry is missing or out of range, for example. Similarly, if an expected field, such as the room temperature, is missing from the table, CPU 1204 may display a warning feedback message. For example, in FIG. 12A when the value −138° is erroneously entered with a negative sign for the boiling point of acetic anhydride, CPU 1204 checks the corresponding value stored in a database, which is not shown in the drawing, and produces a feedback message 1208 “data out of range” to warn the user. Although not explicitly described in the present invention, similar and additional in-progress feedback integrated into a wide range of adaptive learning processes may be implemented using the present invention to help reduce the student's frustration and improve his work quality and overall learning experience without much additional effort from the teacher.

In sum, the present invention provides a system and methods for providing continuous monitoring and immediate personal feedback to every learner in a group in the fashion similar to a personal tutor or a human mentor. The advantages of such a system include the ability to offer timely care to the individual in a group learning setting so as to enhance the overall learning experience of each student and achieve greater learning efficiency.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

### GLOSSARY

1. Work Item—a statement or a description of a problem or a task that requires a response, such as: a solution, an answer or a language-based product, to be developed in a pre-defined form so that the response can be evaluated for education purposes. For example: a homework item, an assignment item or a test item that requires a student to develop an answer, a report or an essay in a computer-readable form so that the teacher may evaluate the student's answer, report or essay with the help of a computer program.
2. Granularity Level—the level of physical and contextual information relates to user input to a computer. For example, when using a stylus to write on a touchscreen tablet, the lowest Granularity Level information may include the time and the position of the stylus touching the touchscreen. Such information can be used to derive successively higher level information such as the length and other geometric properties of the strokes formed by the stylus position on the screen, the letters and symbols formed by the strokes, the words formed by the letters and symbols, the phrases and sentences formed by the words and the paragraphs formed by the sentences, for example.
3. Tiered Granularity Levels—a set of related granularity levels organized in a contextually hierarchical fashion.
4. In-progress Feedback—feedback issued while the response to a work item is being developed. Unlike Snapshot based feedback, which analyzes the final version of the response with or without a few snapshots taken at pre-determined stages of the development of the work item response, In-Progress Feedback performs analysis on work item response throughout the development process continuously even without the concept or need of pre-determined stages or snapshot points.

What is claimed is:

1. In a computerized learning system a method for providing in-progress feedback comprising:
providing a work item to a learner via a display device;
detecting input activities from the learner in response to the work item via an input device compatible with the display device;
analyzing the input activities at two or more tiered levels of granularity; and
providing feedback to the learner, wherein the feedback includes at least one of praise, warning, hint, progress evaluation and performance evaluation, and wherein the feedback is provided when a pre-defined condition is met based on the analysis of input activities.

2. The method of claim 1 wherein the tiered levels includes at least one pair of sub-stroke level and stroke level, character level and symbol level, word level and phrase level, sentence level and equation level, paragraph level and essay level.

3. The method of claim 1 wherein the pre-defined condition is based on a pre-defined rule.

4. The method of claim 3 wherein the pre-defined rule includes at least one of user input property matching pre-defined said work item related property, user input property not matching pre-defined said work item related property, user input property partially matching pre-defined said work item related property.

5. The method of claim 1 wherein the pre-defined condition includes no user activity detected over a pre-determined time period.

6. The method of claim 1 wherein the at least two or more tiered levels of granularity are configurable.

7. The method of claim 1 wherein the input device and the display device are incorporated into a touchscreen.

8. The method of claim 1 further comprising detecting and analyzing a response of the learner to the feedback.

9. The method of claim 1 further comprising providing a second work item based on the analysis of the input activities.

10. The method of claim 1 wherein providing the feedback depends on an identity of the learner.

11. A computerized learning system comprising:
a display device configured to provide a work item to a learner;
an input device configured to detect input activities from the learner in response to the work item, wherein the input device is compatible with the display device;
a processor configured to analyze the input activities at two or more tiered levels of granularity; and
wherein the display device is further configured to provide feedback to the learner, wherein the feedback includes at least one of praise, warning, hint, progress evaluation and performance evaluation, and wherein the feedback is provided when a pre-defined condition is met based on the analysis of input activities.

12. The computerized learning system of claim 11 wherein the tiered levels includes at least one pair of sub-stroke level and stroke level, character level and symbol level, word level and phrase level, sentence level and equation level, paragraph level and essay level.

13. The computerized learning system of claim 11 wherein the input activities include at least one of screen tapping, screen writing, screen drawing, screen pinching, device rotation, device shaking, voice input and button pressing.

14. The computerized learning system of claim 11 wherein the feedback includes at least one of sound, text, graphics, voice and video.

15. The computerized learning system of claim 11 wherein the pre-defined condition depends on at least one of the work item and an identity of the learner.

16. The computerized learning system of claim 11 further configured to provide a second work item based on the analysis of the input activities.

17. The computerized learning system of claim 16 further configured to provide the second work item based on prior in-progress feedback.

18. The computerized learning system of claim 11 further comprising a second display device for a second learner, wherein an identical second work item is provided via both display devices based on the analysis of input activities of both learners.

19. A storage mechanism useful in association with a computerized learning system configured to analyze input activities of at least one learner in response to a first work item at two or more tiered levels of granularity and to generate in-progress feedback without interrupting the input activities, wherein the storage mechanism is configured to store responses of the at least one learner and the computerized learning system is further configured to provide a second work item based on the analysis of the input activities and content from the storage mechanism.
